(19) United States
(12) Patent Application Publication
(10) Pub. No.: US 2015/0294045 A1
(43) Pub. Date: Oct. 15, 2015

(54) APPARATUS AND METHOD FOR MODELING OF HYBRID SYSTEM

(71) Applicant: Electronics and Telecommunications Research Institute, Daejeon (KR)

(72) Inventors: Jae Ho JEON, Daejeon (KR); In Geol CHUN, Daejeon (KR); Won Tae KIM, Asan-si (KR)

(73) Assignee: ELECTRONICS AND TELECOMMUNICATIONS RESEARCH INSTITUTE, Daejeon (KR)

(21) Appl. No.: 14/606,046

(22) Filed: Jan. 27, 2015

(30) Foreign Application Priority Data
Apr. 9, 2014 (KR) 10-2014-0042378

(51) Int. Cl. G06F 17/50

(52) U.S. Cl. CPC G06F 17/5009; G06F 17/5095

(57) ABSTRACT

Disclosed is an apparatus for modeling of a hybrid system and the apparatus includes: a model configuring unit modeling ports, structures, and constraints for one or more cyber physical systems implemented in the hybrid system and constituting a core model including a port model, a structure model, and a constraint model constituted for each cyber physical system; and a model setting unit setting a connection relationship of the port model, the structure model, and the constraint model for each core model and defining a discrete component and a continuous component for each model.

### CROSS-REFERENCE TO RELATED APPLICATIONS

This application claims priority to and the benefit of Korean Patent Application No. 10-2014-0042378 filed in the Korean Intellectual Property Office on Apr. 9, 2014, the entire contents of which are incorporated herein by reference.

### TECHNICAL FIELD

The present invention relates to an apparatus for modeling of a hybrid system, and more particularly, to a technology that constructs a model including both a discrete component and a continuous component of the hybrid system.

### BACKGROUND ART

When frameworks or apparatuses that develop an embedded system at a model level are described at present, in most cases, a language suitable for expressing only a discrete component such as a unified modeling language (UML) mostly used for analyzing and designing development of a software system is used.

However, systems implemented at present are not constituted by a single system any longer and have a characteristic of system of systems like cyber physical systems. Therefore, since the UML is not suitable for expressing a continuous system calculated by a differential equation, there is a limit in expressing a system having a complex domain through the UML.

A modeling apparatus that can express as a model the discrete component and the continuous component is required in order to solve the problem.

### SUMMARY OF THE INVENTION

The present invention has been made in an effort to provide an apparatus for modeling of a hybrid system that can express all of ports, structures, and constraints of respective systems implemented in the hybrid system including both a discrete component and a continuous component through modeling.

An exemplary embodiment of the present invention provides an apparatus for modeling of a hybrid system, including: a model configuring unit modeling ports, structures, and constraints for one or more cyber physical systems implemented in the hybrid system and constituting a core model including a port model, a structure model, and a constraint model constituted for each cyber physical system; and a model setting unit setting a connection relationship of the port model, the structure model, and the constraint model for each core model and defining a discrete component and a continuous component for each model.

The model setting unit may define the components to include a port name, a port type, and a data type for an input port and an output port included in the port model.

The model setting unit may define the port type so that the port type is classified into any one of a continuous value, a discrete value, a constant value, and a discrete event.

The model setting unit may define the data type as any one of a real number, an integer number, a double, a Boolean, and a vector.

The model setting unit may define an initial value within a range of the data type in respect to the output port.

The initial value defined for the output port may vary depending on a value transferred from the input port.

The model setting unit may define a constraint so as to permit only read and prevent write for an input port in which the port type is classified into any one of the continuous value, the discrete value, and the discrete event.

The model setting unit may define the constraint so as to permit read and partially permit write in accordance with a condition for an output port in which the port type is classified into any one of the continuous value, the discrete value, and the constant value, and to prevent read and partially permit write in accordance with the condition for an output port in which the port type is classified into the discrete event.

The model setting unit may define the constraint so as to permit connection of ports in which the port type and the data type are the same as each other, in respect to the input port and the output port.

When a port type of a port providing data between connected ports is classified into the discrete event and a port type of a port receiving data is classified into the continuous value or the discrete value, in respect to the input port and the output port, the model setting unit may define the constraint so as to permit the connection when data types of the corresponding ports are the same as each other.

The structure model may include at least one of a sub model and a behavioral model therein.

The behavioral model may include a regional variable, a status, and a transition component among respective statuses, and may be connected with other models through input ports and output ports.

The model setting unit may define the regional variable to include a classification of the region variable, a regional variable name, a regional variable type, and an initial value.

The model setting unit may define the transition component to include a transition name, a transition condition, and a new status.

The sub model may be connected with the structure model and other sub models in the structure model through input ports and output ports.

A plurality of structure models may be disposed in a layered structure.

According to exemplary embodiments of the present invention, all of ports, structures, and constraints of respective systems implemented in the hybrid system including both a discrete component and a continuous component can be expressed through modeling.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a block diagram illustrating a configuration of an apparatus for modeling of a hybrid system according to an exemplary embodiment of the present invention.

FIG. 2 is an exemplary diagram illustrating a model configuration of the apparatus for modeling of a hybrid system according to the exemplary embodiment of the present invention.

FIG. 3 is an exemplary diagram illustrating a model structure of the hybrid system according to the exemplary embodiment of the present invention.

FIG. 4 is an exemplary diagram illustrating a detailed structure of a structure model according to the exemplary embodiment of the present invention.

FIG. 5 is an exemplary diagram illustrating a detailed structure of an input port model according to the exemplary embodiment of the present invention.

FIG. 6 is an exemplary diagram illustrating a detailed structure of an output port model according to the exemplary embodiment of the present invention.

FIG. 7 is an exemplary diagram illustrating an exemplary embodiment of implementing the structure model according to the exemplary embodiment of the present invention.

FIG. 8 is an exemplary diagram illustrating an exemplary embodiment of implementing a behavioral model according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described in priority and a description of elements which may obscure the spirit of the present invention will be skipped.

Some components of the drawings may be enlarged, omitted, or schematically illustrated. An actual size is not fully reflected on the size of each component and therefore, contents disclosed herein are not limited by relative sizes or intervals of the components drawn in the respective drawings.

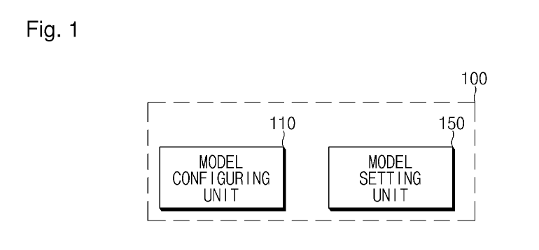

FIG. 1 is a block diagram illustrating a configuration of an apparatus for modeling of a hybrid system according to an exemplary embodiment of the present invention.

Referring to FIG. 1, the apparatus (hereinafter, referred to as a ‘modeling apparatus’) 100 for modeling of a hybrid system according to the exemplary embodiment of the present invention may include a model configuring unit 110 and a model setting unit 150.

First, the model configuring unit 110 constitutes each of a port model, a structure model, and a constraint model and constitutes a core model including the port model, the structure model, and the constraint model.

Herein, the model configuring unit 110 may constitute a plurality of port models, structure models, and constraint models included in the core model and each of the plurality of models constituted at this time may be disposed in a layered structure. Further, the model configuring unit 110 may constitute a sub model in the structure model. The model configuring unit 110 may constitute a behavioral model for the structure model.

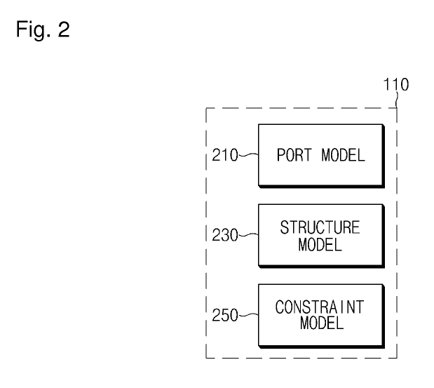

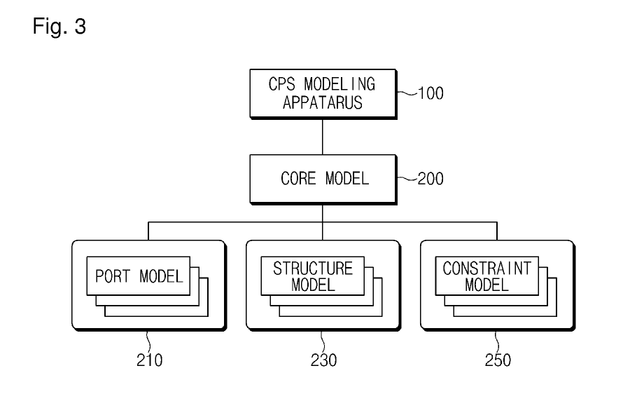

A detailed description for each model constituted by the model configuring unit 110 will be described in more detail with reference to FIGS. 2 and 3.

The model setting unit 150 may set a connection relationship of the port model, the structure model, and the constraint model included in the core model and define detailed items of each model.

As one example, the model setting unit 150 may define the structure model included in the core model and define the sub model and/or the behavioral model included in the structure model. In this case, the model setting unit 150 may define a name of the structure model and define a name of the sub model, a name of the behavioral model, a regional variable, a status, and a transition.

The model setting unit 150 may set the port model corresponding to the structure model. In this case, the model setting unit 150 may define an input port and an output port corresponding to the structure model. In this case, the model setting unit 150 may define names, types, and data types of the input port and the output port. The model setting unit 150 may set the port model corresponding to each of at least one sub model and/or behavioral model in the structure model.

The model setting unit 150 may set the constraint model corresponding to the structure model. The model setting unit 150 may set the constraint model corresponding to each of the sub model and/or the behavioral model when at least one sub model and/or behavioral model is included in the structure model. In this case, the model setting unit 150 may define a model constraint condition, a status constraint condition, a transition condition, and the like of the constraint model set to correspond to at least one of the structure model, the sub model, and the behavioral model.

The model setting unit 150 may set the constraint model corresponding to the port model.

The model setting unit 150 sets the connection relationship among the respective models and a detailed description of defined operations will be described in more detail through the following exemplary embodiments.

FIG. 2 is an exemplary diagram illustrating a model configuration of the apparatus for modeling of a hybrid system according to the exemplary embodiment of the present invention.

As illustrated in FIG. 2, the model configuring unit 110 according to the present invention may configure a port model 210, a structure model 230, and a constraint model 250. It is assumed that the port model 210, the structure model 230, and the constraint model 250 are included in the core model 200. In this case, the relationship between the core model 200 of the modeling apparatus 100 and the port model 210, the structure model 230, and the constraint model 250 included in the core model 200 may be represented as illustrated in FIG. 3.

Referring to FIGS. 2 and 3, the port model 210 is a model implemented for a port applied to a virtual physical system of the hybrid system and information exchanges among the respective models are achieved through the port model 210.

The port model 210 may include a model for each of the input port and the output port. Herein, the port model 210 may be connected with at least one structure model 230. When the sub model and/or the behavioral model are included in the structure model 230, the port model 210 may be connected with the sub model and/or the behavioral model in the structure model 230.

In this case, the input port of the structure model 230 may be connected with the output port of the corresponding structure model 230 and may be connected with the input port of the sub model and/or the behavioral model in the structure model 230. Meanwhile, the input port of the structure model 230 may be connected with the output port of other structure model 230. The output port of the structure model 230 may be connected with the output port of the sub model and/or the behavioral model in the corresponding structure model 230 and connected with the input port of other structure model 230.

The input port and the output port of the sub model and/or the behavioral model included in the structure model 230 may be connected with the input model and the output model of other sub model and/or behavioral model in the structure model 230. In this case, the input/output port of the port model 210 connected with the structure model 230 and the input/output port of the port model 210 connected to the sub model and/or the behavioral model in the structure model 230 may be implemented in a form in which the input/output ports are disposed on the corresponding structure model, and sub model and/or the behavioral model.

Meanwhile, the port model 210 may be connected with even the constraint model 250 according to a set-up.

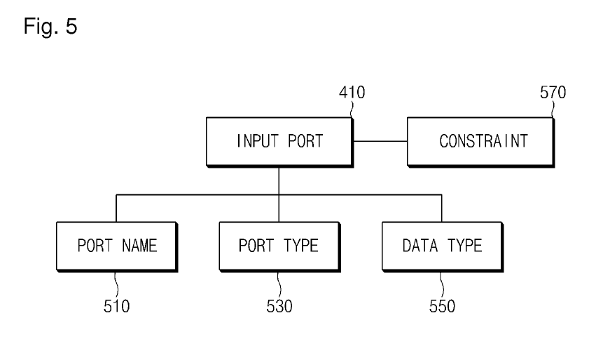

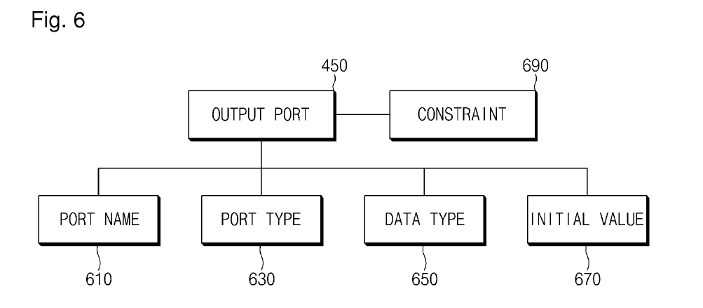

Therefore, a detailed structure of the port model 210 will be described in more detail with reference to FIGS. 5 and 6.

The structure model 230 may include at least one sub model and/or behavioral model in the single structure model 230. When a plurality of sub models and/or behavioral models is included in the structure model 230, the plurality of sub models and/or behavioral models may be disposed in a layered structure. Of course, the structure model 230 of the present invention does not unconditionally include the sub model and/or the behavioral model.

A plurality of structure models 230 may be provided and the plurality of structure models 230 may be disposed in the layered structure.

Herein, layering each model supports encapsulation of the model and enables reusage of the model and multiple resolution modeling. For example, when rapid model execution is required, all or some of the sub models are replaced with the single model to be executed and on the contrary, when very precise model execution is required, the single model is replaced with complex models constituted by a plurality of layered structures to be executed. Further, by modeling various components having the same purpose, respectively, the models of the corresponding components may be executed while being replaced.

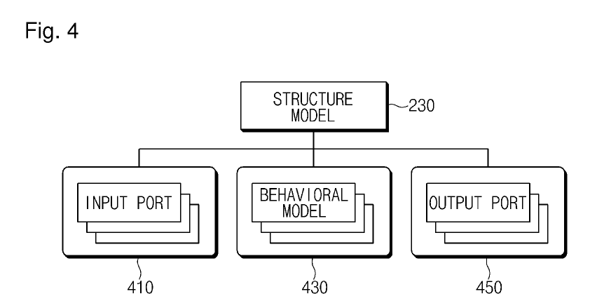

Therefore, a detailed structure of the structure model 230 will be described in more detail with reference to FIG. 4.

The constraint model 250 shows constraints which the core model has. In this case, the constraint model 250 may include the constraints for the structure model 230 and include constraints for the sub models and/or behavioral models included in the structure model 230. Further, the constraint model 250 may include a constraint for the port model 210

FIG. 4 is an exemplary diagram illustrating a detailed structure of a structure model according to the exemplary embodiment of the present invention.

Referring to FIG. 4, the structure model 230 may be set to be connected with the port model. In this case, the structure model 230 may be implemented to include connection-set input ports 410 and output ports 450.

The structure model 230 may communicate with other structure models and/or behavioral models through the input ports 410 and the output ports 450. In this case, the input port 410 reads values output from other models and transfer the read output values to the corresponding structure model 230 and the output port 450 transfers a value output from the corresponding model to the input port of other model.

Even when the sub models and/or the behavioral models are included in the structure model 230, the sub models and/or the behavioral models included in the structure model 230 are connected to each other through the input ports 410 and the output ports 450 to transfer data through the corresponding input ports 410 and output ports 450.

Herein, read/write of the input ports 410 and the output ports 450 may be implemented in a shared memory scheme or a message passing scheme. It is apparent that the read/write schemes of the input ports 410 and the output ports 450 are not limited to any one but the read/write schemes may be variously applied according to the exemplary embodiment.

Meanwhile, the structure model 230 may include a sub model and/or a behavioral model. However, in the exemplary embodiment of FIG. 4, a case where the behavioral model is included is illustrated, but the present invention is not limited thereto.

The behavioral model is to model a behavior of the structure model 230, and the behavior means mapping an output value output through the output port 450 with respect to an input value input through the input port 410. The behavioral models included in the structure model 230 may be expressed in a combination of the behaviors of the structure model 230.

The behavioral model may include a regional variable. Here, the regional variable may be disposed in an empty space in the behavioral model, and may be indicated by a form of ‘[<Classification>]<variable name>:<variable type>=<initial yalue>’.

As an example, the regional variable may be indicated as follows.

[D] Capacity:double=5.5

Here, the classification of the variables may be divided as follows.

[A]: A type indicated when continuous values such as an analog signal are expressed
[C]: Constant—type indicated when a constant value is expressed
[D]: Discrete—type representing a regional variable based on a discrete
[E]: Event—type representing a regional variable based on an event

Meanwhile, in the behavioral model, constraints of the constraint model may be defined. The constraints of the behavioral model update consecutively updated variables or values of the output ports 450. Further, the constraints of the behavioral model may be divided into a model constraint entirely reflected in the behavioral model and a state constraint reflected only in the state of the behavioral model. In this case, the state constraint is applied to only a case where the behavior of the model stays in the corresponding state to change the values of the output ports 450 or the regional variables which are consecutively updated.

Here, one constraint for the behavioral model may be expressed by a differential equation or algebra.

The constraint expressed by the differential equation may be represented by a form such as ‘d(variable)=expression’.

For example, the constraint may be represented as follows.

$$\frac{d t}{d x} ( variable ) = expression$$

Here, a differential value for a time of ‘variable’ is a value of ‘expression’. Such a differential equation is frequently used in a rigid body motion and the like.

In the behavioral model, states and transitions may be defined. As an example, the modeling apparatus may define an initial state of the behavioral model, a name of each state, a state constraint, a transition name, a transition condition, a new state of the transition, and the like. The state constraint may be defined to be available only in application of a constraint rule and the state.

Here, in all the behavioral models, the initial state during at least starting needs to be defined.

The state of the behavioral model represents a central behavior. As an example, a vehicle dynamic model may have states such as acceleration, cruising, and deceleration. In the state, the names may be defined, and the constraints may be added. In this case, due to the constraints in the state, the values of the output ports 450 and the regional variables which are continuously updated may be updated while staying in the corresponding state. When the values of the output ports 450 are updated, the updated values influence external models connected to the corresponding behavioral model.

The transition of the behavioral model means the transition of the state, and when a transition occurrence condition which is pre-defined between a previous state and a next state becomes a logical truth, the transition from the previous state to the next state occurs.

The transition occurrence condition may be represented by a similar form to a condition equation in a common programming language. The transition may change the values of the corresponding output ports 450 or the regional variables when the corresponding transition occurs, by adding the changes of the values of the output ports 450 or the regional variables which are discretely updated by adding a transition action performed during the transition. In this case, the changes of the value of the output ports 450 or the regional variables may be performed together with the transition.

The transition may be suitable for a case where a classification of the output port 450 or the regional variable is an event [E]. A value in which the classification of the output port 450 or the regional variable is a discrete [D] may be appropriately changed by adding the constraint in the state other than the transition. Of course, this is just the exemplary embodiment and is not necessarily limited thereto, and may be variously applied according to a modeling environment or an exemplary embodiment. Here, the transition may be represented by ‘<transition name>[<transition condition>]/<definition of new state>’. In this case, the definition of the new state may be omitted.

For example, the transition may be represented as follows.
fillingCompleted[capabillity<=contentsLevel]/

FIG. 5 is an exemplary diagram illustrating a detailed structure of the input port according to the exemplary embodiment of the present invention.

Referring to FIG. 5, the input port 410 included in a port model may be defined by a port name 510, a port type 530, and a data type 550.

Here, the port name 510 means a name of the input port 410, and the indicated type is not determined, but may be randomly defined.

The port type 520 means a type of the input port 410. As an example, the port type 530 may be indicated by any one of an analog ‘A’ representing a continuous value, a digital ‘D’ representing a discrete value, a constant ‘C’ representing a constant value, and an event ‘E’ representing a discrete event. Of course, according to an exemplary embodiment, a type indicating the port type 530 of the input port 410 may be added.

The data type 550 means a type of a value of the port, and is similar to a variable type in the programming language. As an example, the data type 550 may be indicated by any one of a real number ‘Real’, an integer ‘int’, a double ‘double’, and a boolean ‘Bool’. Of course, according to an exemplary embodiment, a type indicating the data type 550 of the input port 410 may be added.

In this case, the input port 410 may be defined by [<port type>]<port name>:<data type>′. For example, the input port 410 may be indicated as follows.
[A] inflow:double

Meanwhile, in the input port, constraints 570 of the constraint model may be defined. For example, in the input port 410, the constraints may be defined as follows.

Continuous Value Input Port
Read: possible
Write: impossible

Discrete Value Input Port
Read: possible
Write: impossible

Discrete Event Input Port
Read: possible
Write: impossible

FIG. 6 is an exemplary diagram illustrating a detailed structure of the output port according to the exemplary embodiment of the present invention.

Referring to FIG. 6, the output port 450 included in the port model may be defined by a port name 610, a port type 630, a data type 650, and an initial value 670.

Here, the port name 610 means a name of the output port 450, and the indicated type is not determined, but may be randomly defined.

The port type 630 means a type of the output port 450. As an example, the port type 630 may be indicated by any one of an analog ‘A’ representing a continuous value, a digital ‘D’ representing a discrete value, a constant ‘C’ representing a constant value, and an event ‘E’ representing a discrete event, like the port type 630 of the input port. Of course, according to an exemplary embodiment, a type indicating the port type 630 of the output port 450 may be added.

The data type 650 means a type of a value of the output port 450, and is similar to a variable type in the programming language. As an example, the data type 650 may be indicated by any one of a real number ‘Real’, an integer ‘int’, a double ‘double’, a boolean ‘Bool’, and a vector ‘Vector’, like the data type 650 of the input port. Of course, according to an exemplary embodiment, a type indicating the data type 650 of the output port 450 may be added.

Meanwhile, in the output port 450, unlike the input port, the initial value 670 is additionally defined. The initial value 670 may be randomly defined within a range which may be expressed in the data type 650 of the corresponding output port 450. The output port 450 may be defined by ‘[<port type>]<port name>:<data type>=<initial value>’. Here, the initial value 670 may vary according to a value transferred from the input port, and may be omitted according to an exemplary embodiment.

For example, the output port 450 may be indicated as follows.
[A] Velocity:Vector
[A] contentsLevel:double=0

Meanwhile, in the output port, constraints 690 of the constraint model may be defined. For example, in the output port 450, the constraints may be defined as follows.

Continuous Value Output Port
Read: possible
Write: Conditionally possible

Constant Value Output Port
Read: possible
Write: Conditionally possible

Discrete Value Output Port
Read: possible
Write: Conditionally possible

Discrete Event Output Port
Read: impossible
Write: Conditionally possible

Here, the conditionally possible means that write is possible according to a value transferred from the input port. That is, since the write value of the output port varies according to the value transferred from the input port, in some cases, the write value may be ‘impossible’ or ‘possible’.

Meanwhile, in the input port and the output port input between the models, commonly, the following constraints may be defined.
Port types and data types of two ports which are connected to each other need to be the same as each other (however, an original port type is [E], a target port type is [A] or [D], and when the data types of the two ports are the same as each other, the two ports may be connected to each other)
Structure model input port→Sub model input port
Sub model output port→Structure model output port
Sub model M1 output port→Sub model M2 input port (here, M₁≈M₂)
Structure model input port→Structure model output port

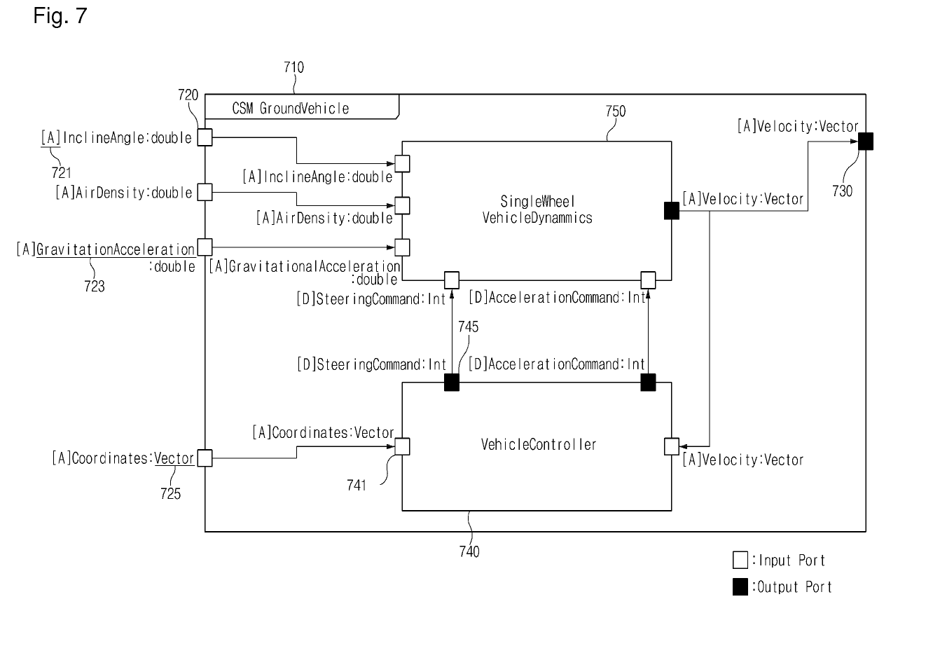

FIG. 7 is an exemplary diagram illustrating an exemplary embodiment of implementing the structure model according to the exemplary embodiment of the present invention.

Referring to FIG. 7, reference numeral 710 represents a vehicular structure model and a name of the corresponding vehicular structure model 710 is defined as ‘CSM Ground Vehicle’.

The vehicular structure model 710 may be implemented in a form in which four input ports 720 and one output port 730 are disposed. In FIG. 7, the input ports are represented by ‘□’ and the output port is represented by ‘▪’.

In this case, the input ports 720 are defined as ‘[A] InclineAngle:double’, ‘[A] AirDensity:double’, ‘[A] GravitationalAcceleration:double’, and ‘[A] Coordinates:Vector’, respectively. Herein, reference numeral 721 represents a port type of the corresponding port, reference numeral 723 represents a port number of the corresponding port, and reference numeral 725 represents a data type of the corresponding port. Meanwhile, the output port is defined as ‘|A| Velocity:Vector’.

The vehicular structure model 710 includes two sub models 740 and 750 therein and an input port 741 and an output port 745 may also be disposed at each of the sub models 740 and 750.

Herein, the sub model of the vehicular structure model 710 may correspond to ‘VehicleController’ 740 and ‘SingleWheel VehicleDynamics’ 750.

The input port 741 of ‘VehicleController’ 740 may be connected with the input port ‘[A] Coordinates:Vector’ of the vehicular structure model 710 and in this case, the input port 741 of the ‘VehicleController’ 740 is defined as the ‘[A] Coordinates:Vector’ similarly to the connected input port of the vehicular structure model 710. Meanwhile, other input port of the ‘VehicleController’ 740 may be connected with the output port of the other sub model ‘SingleWheel VehicleDynamics’ 750 and in this case, the connected ports are similarly defined as the ‘|A| Velocity:Vector’.

The output ports 745 of the ‘VehicleController’ 740 may be connected with the input ports of the other sub model ‘SingleWheel VehicleDynamics’ 750 and in this case, the connected ports are defined as ‘[D] SteeringCommand:Int’ and ‘[D] AccelerationCommand:Int’, respectively.

Meanwhile, the input ports of ‘SingleWheel VehicleDynamics’ 750 may be connected with [A] InclineAngle:double’, ‘[A] AirDensity:double’, and ‘[A] GravitationalAcceleration:double’ which are the input ports of the vehicular structure model 710, respectively. In this case, the input ports of the ‘SingleWheel VehicleDynamics’ 750 are defined similarly as the connected input ports of the vehicular structure model 710. Further, the output port ‘[A] Velocity:Vector’ of the ‘SingleWheel VehicleDynamics’ 750 may be connected with the input port of the other sub model ‘VehicleController’ 740 and further, may be connected with even the output port ‘[A] Velocity:Vector’ of the vehicular structure model 710.

Accordingly, in the vehicular structure model 710 illustrated in FIG. 7, values input into the respective input ports are finally output through the output port ‘[A] Velocity:Vector’ of the vehicular structure model 710 via internal sub models.

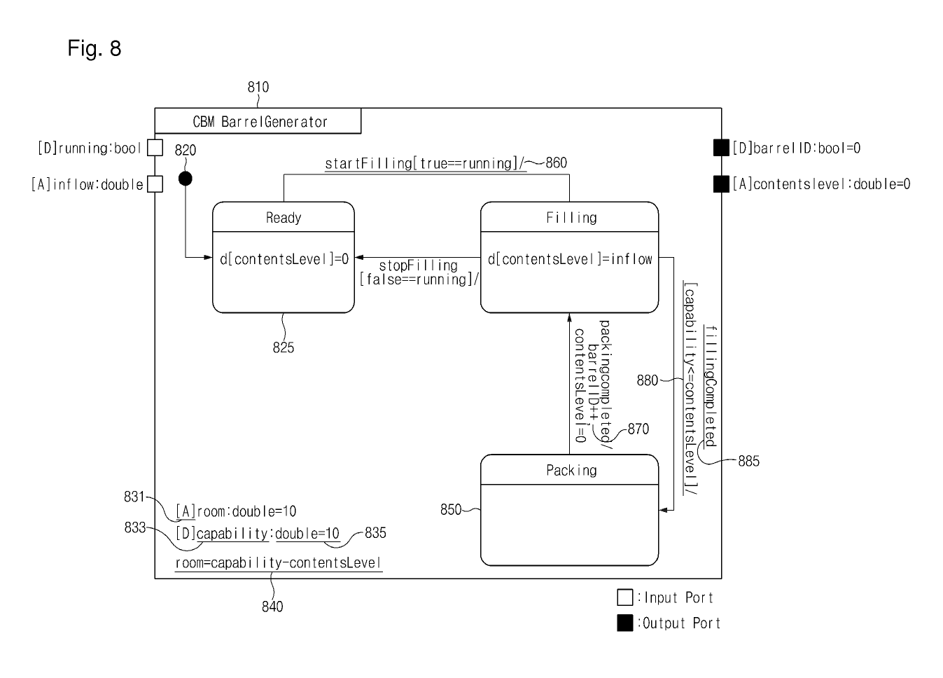

FIG. 8 is an exemplary diagram illustrating an exemplary embodiment of implementing a behavioral model according to the exemplary embodiment of the present invention.

Referring to FIG. 8, reference numeral 810 represents a generator behavioral model corresponding to ‘CBM BarrelGenerator’.

The generator behavioral model 810 may be implemented in a form in which two input ports and two output ports are respectively disposed. Herein, the input ports may be defined as ‘D running:bool’ and ‘[A] inglow:double’ and the output ports may be defined as ‘[D] barrelID:bool=0’ and ‘[A] contentsLevel:double=0’.

A regional variable may be defined in the generator behavioral model 810. Herein, the regional variable may be defined as [Aroom:double=10’, [D capability:double=10′. In this case, reference numeral 831 represents a classification of the regional variable, reference numeral 833 represents a regional variable name, and reference numeral 835 represents a regional variable type. Further, a model constraint condition such as ‘room=capability−contsLevel’ 840 may be defined in the generator behavioral model 810.

Respective statuses, for example, ‘Ready’ 821, ‘Filling’ 823, ‘Packing’ 825, and the like may be defined in the generator behavioral model 810 and an initial status 820 of the generator behavioral model 810 may be defined. In this case, a status name and a status constraint condition may be defined in the respective statuses 821, 823, and 825.

As one example, a constraint condition such as ‘d[contentsLevel]=0’ may be defined in the status ‘ready’ 821 and a constraint condition such as ‘d[contentsLevel]=inflow’ may be defined in the status′Filling′ 823.

Transition among the respective statuses ‘Ready’ 821, ‘Filling’ 823, and ‘Packing’ 825 may be defined. In this case, a transition name 885, a transition condition 880, a transition behavior 870, and the like may be defined

As one example, when the transition condition such as ‘startFilling [true==running]/’ 860 is satisfied in the status ‘Ready’ 821, the status ‘Ready’ 821 may be defined to be transited to the status ‘Filling’ 823. Meanwhile, when the transition condition such as ‘stopFilling [false==running]/’ 850 is satisfied, the status ‘Filling’ 823 may be defined to be transited to the status ‘Ready’ 821.

When the transition condition such as ‘packingCompleted/barrelID++, contentsLevel=0’ is satisfied in the status ‘Packing’ 825, the status ‘Ready’ 821 may be defined to be transited to the status ‘Filling’ 823. Meanwhile, when a transition condition such as ‘fillingCompleted [capability<=contentsLevel]/’ is satisfied, the status ‘Filling’ 823 may be defined to be transited to the status ‘Parking’ 825.

Meanwhile, the present invention can be implemented by a processor readable code in a processor readable recording medium when various exemplary embodiments discussed above are executed by one or more computers or processors. The processor readable recording medium includes every type of recording device in which data readable by a processor is stored. Examples of the processor readable recording medium include ROM, RAM, CD-ROM, a magnetic tape, a floppy disk, an optical data storing device and the processor readable recording medium may also be implemented in a form of a carrier wave such as transmission through the Internet. The processor readable recording medium is distributed in computer systems connected through a network and a processor readable code is stored therein and executed in a distributed manner.

The present invention has been described by the specified matters and limited embodiments and drawings such as specific components in the present invention for illustrative purposes, but they are provided to assist more overall appreciation and the present invention is not limited to the exemplary embodiments, and those skilled in the art will appreciate that various modifications and changes can be made, without departing from an essential characteristic of the present invention. The spirit of the present invention should not be defined only by the described exemplary embodiments, and it should be appreciated that and claims to be described below and all technical spirits which evenly or equivalently modified are included in the claims of the present invention.

What is claimed is:

1. An apparatus for modeling of a hybrid system, the apparatus comprising:
a model configuring unit modeling ports, structures, and constraints for one or more cyber physical systems implemented in the hybrid system and constituting a core model including a port model, a structure model, and a constraint model constituted for each cyber physical system; and
a model setting unit setting a connection relationship of the port model, the structure model, and the constraint model for the core model and defining a discrete component and a continuous component for each model.

2. The apparatus of claim 1, wherein the model setting unit defines the components to include a port name, a port type, and a data type for an input port and an output port included in the port model.

3. The apparatus of claim 2, wherein the model setting unit defines the port type so that the port type is classified into any one of a continuous value, a discrete value, a constant value, and a discrete event.

4. The apparatus of claim 2, wherein the model setting unit defines the data type as any one of a real number, an integer number, a double, a Boolean, and a vector.

5. The apparatus of claim 2, wherein the model setting unit defines an initial value within a range of the data type in respect to the output port.

6. The apparatus of claim 5, wherein the initial value defined for the output port varies depending on a value transferred from the input port.

7. The apparatus of claim 3, wherein the model setting unit defines a constraint so as to permit only read and prevent write for an input port in which the port type is classified into any one of the continuous value, the discrete value, and the discrete event.

8. The apparatus of claim 3, wherein the model setting unit defines the constraint so as to permit read and partially permit write in accordance with a condition for an output port in which the port type is classified into any one of the continuous value, the discrete value, and the constant value, and
to prevent read and partially permit write in accordance with the condition for an output port in which the port type is classified into the discrete event.

9. The apparatus of claim 3, wherein the model setting unit defines the constraint so as to permit connection of ports in which the port type and the data type are the same as each other, in respect to the input port and the output port.

10. The apparatus of claim 3, wherein when a port type of a port providing data between connected ports is classified into the discrete event and a port type of a port receiving data is classified into the continuous value or the discrete value, in respect to the input port and the output port, the model setting unit defines the constraint so as to permit the connection when data types of the corresponding ports are the same as each other.

11. The apparatus of claim 1, wherein the structure model includes at least one of a sub model and a behavioral model therein.

12. The apparatus of claim 11, wherein the behavioral model includes a regional variable, a status, and a transition component among respective statuses, and is connected with another models through input ports and output ports.

13. The apparatus of claim 12, wherein the model setting unit defines the regional variable to include a classification of the region variable, a regional variable name, a regional variable type, and an initial value.

14. The apparatus of claim 12, wherein the model setting unit defines the transition component to include a transition name, a transition condition, and a new status.

15. The apparatus of claim 11, wherein the sub model is connected with the structure model and other sub models in the structure model through input ports and output ports.

16. The apparatus of claim 1, wherein a plurality of structure models is disposed in a layered structure.
